(19) United States
(12) Patent Application Publication
(10) Pub. No.: US 2025/0256846 A1
(43) Pub. Date: Aug. 14, 2025

(54) CABIN SECTION OF A PASSENGER CABIN OF A PASSENGER AIRCRAFT HAVING A BED SUPPORTED AGAINST A FLIGHT ATTENDANT SEAT

(71) Applicant: Diehl Aviation Laupheim GmbH, Laupheim (DE)

(72) Inventors: Silvan Fiedler, Dornstadt (DE); Matthias Haas, Achstetten (DE); Sebastien Pauleau, Burgrieden (DE); Hossein Mokari Asl, Graz (AT)

(21) Appl. No.: 19/169,171

(22) Filed: Apr. 3, 2025

Related U.S. Application Data
(63) Continuation of application No. PCT/EP2024/051090, filed on Jan. 18, 2024.

(30) Foreign Application Priority Data
Jan. 23, 2023 (DE) 10 2023 101 497.8

(51) Int. Cl. B64D 11/00; B64D 11/06

(52) U.S. Cl. CPC B64D 11/00; B64D 11/0639; B64D 11/0691; B64D 2011/0076

(57) ABSTRACT

A cabin section of a passenger cabin of a passenger aircraft includes a flight attendant seat movable between a state of use and a stowed state, a bed movable between a state of use and a stowed state, and a floor section of a floor of the passenger cabin. The floor section is located between the flight attendant seat and the bed and is available for being walked on, when the flight attendant seat and the bed are both in the stowed state. The floor section is partially covered by the flight attendant seat in the state of use, is at least partially covered by the bed in the state of use, and is completely covered by both when the bed is in the state of use. The bed is supported against the flight attendant seat in the state of use.

### CROSS-REFERENCE TO RELATED APPLICATION

This application is a continuation, under 35 U.S.C. § 120, of copending International Patent Application PCT/EP2024/051090, filed Jan. 18, 2024, which designated the United States; this application also claims the priority, under 35 U.S.C. § 119, of German Patent Application DE 10 2023 101 497.8, filed Jan. 23, 2023; the prior applications are herewith incorporated by reference in their entirety.

### FIELD AND BACKGROUND OF THE INVENTION

The invention relates to a cabin section of a passenger cabin of a passenger aircraft having a bed supported against a flight attendant seat.

German Application DE 10 2008 039 635 A1, corresponding to U.S. Pat. No. 8,413,268 B2, discloses such beds in the form of a bed arrangement having a first support element and a lying-down facility. The lying-down facility has a first fastening region, which, in turn, has a first fastening element and a second fastening element. The lying-down facility is attached to the support element using the first and the second fastening element. The lying-down facility can be moved or pivoted between a first state, in which the lying-down facility is disposed substantially horizontal, and a second state, wherein the transition between the first and the second state takes place as a combined rotary and translational movement.

U.S. Publication No. 2022/0388660 A1 discloses a resting area system and a method for an internal cabin of a vehicle, including a monument and a bed module connected to the monument. The bed module includes one or more beds. The bed module is movable between a stowed position and a deployed position relative to the monument.

International Publication WO 2020/222193 A1 discloses a multifunctional area on an aircraft or other passenger transportation vehicle that can be modified in various ways to allow various activities at different points on a journey. For example, one configuration can allow seating for the crew. Another configuration can allow a resting area for the crew.

U.S. Publication No. 2018/0273185 A1 discloses an aircraft cabin arrangement including at least one flight attendant seat, called a high-comfort seat, which can assume a stowed position, a sitting position and at least one rest position, and at least one furniture unit, wherein the high-comfort seat is installed in a space provided in the furniture unit, or can extend at least partially into a space disposed in the furniture unit when the high-comfort seat is in the rest position.

### SUMMARY OF THE INVENTION

It is accordingly an object of the invention to provide an improved cabin section of a passenger cabin of a passenger aircraft having a bed supported against a flight attendant seat, which overcomes the herein aforementioned disadvantages of the heretofore-known devices of this general type.

With the foregoing and other objects in view there is provided, in accordance with the invention, a cabin section of a passenger cabin of a passenger aircraft, comprising a flight attendant seat, which can be adjusted between a state of use and a stowed state, the flight attendant seat being a folding seat with a seat back mounted in a fixed manner in the passenger aircraft, and a basic frame, the movable seat bottom of which can be folded upward about a horizontally extending folding axis to assume the stowed state, a bed, which can be adjusted between a state of use and a stowed state, the bed being a folding bed, which can be folded upward about a horizontal folding axis into the stowed state, a floor section of a floor of the passenger cabin, which floor section is located—when the flight attendant seat and the bed are both in the stowed state—between the flight attendant seat and the bed, such that the flight attendant seat and the bed are at opposite ends of the floor section and delimit the latter there, and make it available to be walked on, the floor section being partially covered by the flight attendant seat in the state of use and at least partially covered by the bed in the state of use, and completely covered by both, and the bed in the state of use being supported on the flight attendant seat.

Preferred or advantageous embodiments of the invention and other categories of invention will become apparent from the other claims, the following description and the appended figures.

In other words, the cabin section is provided for the purpose of being installed in a passenger cabin of the intended type in a passenger aircraft of the intended type or to become part of such a passenger cabin or such a passenger aircraft.

“Of the intended type” means that the cabin section is configured for a particular or a particular type of passenger cabin/passenger aircraft and is set up for use there; e.g. is configured for the geometry requirements, etc. determined thereby. In other words, in particular, a relevant passenger cabin/passenger aircraft is presupposed as known with respect to its geometry, size, material properties, etc.

Thus, the invention relates, in particular, also to a passenger cabin with a corresponding cabin section or a passenger aircraft with the corresponding passenger cabin.

The cabin section contains one flight attendant seat or else, in particular, a plurality of such seats. The flight attendant seat (also referred to as “seat” for short) can be adjusted between a state of use and a stowed state. In the stowed state, the flight attendant seat assumes a space-saving configuration, but it is then not possible for someone to sit there as envisaged. In the state of use, it is configured to enable a flight attendant to sit on it (or else, in principle, some other person). The adjustability is, in particular, foldability, in particular about a horizontally extending folding or pivoting axis. Here, “horizontal” refers to the intended installation state of the cabin section in the passenger aircraft and to a passenger aircraft resting on a level underlying surface. In other words, the flight attendant seat is, in particular, a folding seat with a seat back mounted in a fixed manner in the aircraft, and a basic frame, the movable seat bottom of which can be folded upward to assume the stowed state.

The cabin section contains a bed (or rest platform) or, in particular, a plurality of beds. Such beds are used to enable flight crew on the aircraft, e.g. flight attendants, to rest or sleep there during longer flights. Such beds should not be confused with passenger seats, which may likewise have a sleeping position. The bed can also be adjusted between a state of use and a stowed state. In particular, this is a corresponding folding bed (comparable to the folding seat), which can likewise be folded upward about a horizontal axis into the stowed state. In the lowered state, the bed forms a lying surface, in particular a level lying surface (horizontal when the aircraft is resting on the level), on which a person, in particular a flight attendant, can lie in order to sleep or rest.

The cabin section contains a floor section of a floor of the passenger cabin. When both the flight attendant seat and the bed are in the stowed state, the floor section is located between the flight attendant seat and the bed. In other words, the flight attendant seat and the bed are at opposite edges/ends of the floor section and delimit the latter there. The floor section is therefore available to be walked on. In other words, people can walk on or pass through the floor section or use it as a passage etc.; they are not hindered in doing this by the flight attendant seat and the bed.

In the state of use of the flight attendant seat, the floor section is partially covered by the flight attendant seat, in particular by the seat bottom thereof. When the bed is in the state of use, it (in particular the moving section thereof, see below) covers the floor section at least partially, in particular completely. At least, the flight attendant seat and the bed jointly cover the floor section completely. Normally, it is then no longer possible for people to access or pass through the floor section.

“Delimit” and “cover” should be understood with reference to a normal direction/plan view/projection of the flight attendant seat/bed onto the passenger cabin floor, assumed to be horizontally level, in the relevant area.

When the bed is in the state of use, it is supported on the flight attendant seat. The support for the bed on the flight attendant seat can be provided on any structural part of the seat, e.g. on the seat back thereof or a structural part of a fixed frame.

According to the invention, there is the advantage that no additional devices have to be provided to support the bed, e.g. separate supports on the bed. The flight attendant seat thus performs a dual function, namely accommodating a flight attendant, on the one hand, and supporting the bed, on the other hand. In particular, these two possibilities remain alternatives that cannot be used together.

The flight attendant seat leads to additional strength and stiffness of the bed in the state of use. Airlines fulfill the requirement for crew rest facilities and save costs for additional crew capacity. In principle, the beds can also be booked by passengers. No passenger seats are reserved for crew. An improved rest facility for the crew is provided in an area of the aircraft provided for this purpose. A crew rest compartment with a footprint for optimized layout options is obtained.

In one preferred embodiment, the bed is supported on a seat bottom of the flight attendant seat when the bed is in the state of use. In this situation, the seat bottom is, in particular, in the state of use. In other words, there is then no flight attendant sitting on the seat bottom; instead, the bed is resting on the seat bottom (which is, in particular, folded down). This leads, in particular, to a particularly simple procedure for supporting the bed since, more specifically, the flight attendant seat merely has to be brought first of all into the state of use so that it can then receive or support the bed in the state of use on its seat bottom.

In one preferred embodiment, the cabin section contains a cabin wall section. This is a wall section of a cabin wall of the passenger cabin. The section is, in particular, a section of the washroom wall. The flight attendant seat is mounted in a fixed manner on the cabin wall section. Since this is the usual method of attachment of flight attendant seats, conventional flight attendant seats and conventional configurations of a passenger cabin and of a passenger aircraft can be used to implement the invention. In other words, a bed must merely be provided in a suitable geometrical alignment relative to an existing flight attendant seat in an aircraft or a passenger cabin. This can take place, in particular, in the context of a retrofit.

In one preferred embodiment, the floor section is a floor section directly adjoining a boarding or entrance door, i.e. a boarding/entrance/emergency exit region of the passenger cabin. In particular, the entrance door is a component part of the cabin section.

In other words, the floor section is part of the entrance region/emergency exit region of the passenger cabin. Such an entrance region is generally subject to little or no use while a passenger aircraft is in flight inasmuch as there is no need or only seldom any need to pass through this region. Coverage by the bed thus generally causes no disruption there.

In particular, this concerns the entrance door which is furthest forward in the direction of flight of the aircraft. (For example: “front left in the direction of flight”).

In particular, the flight attendant seat is disposed in front of the bed when viewed in the direction of flight of the passenger aircraft, that is to say on the side of the bed facing the cockpit. This relates to the installation of the cabin section in the passenger cabin or passenger aircraft in the manner intended. In combination with the installation situation at the forwardmost entrance door, the passenger seat region thus follows behind the bed when viewed counter to the direction of flight. The bed and the flight attendant seat are thus located between the passenger seats, on the one hand, and the cockpit, on the other hand. In the case where a bed is being retrofitted in an existing aircraft, it may thus only be necessary to move the passenger seats located behind the bed a short distance toward the rear in order to create sufficient space for a corresponding bed.

In one preferred embodiment, the bed or the lying surface/lying part (in physical form at least in the state of use) has at least one moving section. Here, “at least” refers to the “ . . . section” and should be understood to mean that the entire lying surface may also form the moving section. In the stowed state of the bed, the moving section is adjusted relative to its position in the state of use. In other words, the moving section is a movable/adjustable part of the bed. In particular, the moving section can be folded up into the stowed state, as explained above.

In one preferred variant of this embodiment, the moving section is not capable of further adjustment within itself. Here, the “adjustability” refers to the adjustment of the bed between the state of use and the stowed state. Thus, for example, the moving section itself is not configured to be capable of further folding/movement, telescoping etc. upon itself. Apart from this, there may be fine adjustment of the moving section in the state of use. For example, it may quite possibly be capable of being set/adjusted to a certain extent in the state of use in order, for example, to allow a certain inclination adjustment (e.g. desired raising of legs) in a lying position. In other words, the adjustability of the moving section as a whole is the only adjusting movement necessary to switch the bed between the state of use and the stowed state.

In one preferred variant of this embodiment, the bed or the lying surface thereof contains a fixed section in addition to the moving section. The fixed section is not adjusted/cannot be adjusted between the state of use and the stowed state. In other words, adjustment of the fixed section is not necessary in order to adjust the bed between the state of use and the stowed state. Here too, however, fine adjustment/fine setting may be possible—in a manner similar to that above—e.g. such that the fixed section is a head component of the bed/lying surface, the inclination of which can be adjusted. In particular, the fixed section forms a lying region which is intended for the head or upper body of a person, while the moving section is a lying surface for the rest of the body or the lower body.

In one preferred embodiment, the cabin section contains a cupboard monument. The cupboard monument contains the bed and a first wall section of a sleeping-space wall. Here, “contains” refers especially to the stowed state of the bed. In the state of use, at least part of the bed may also “protrude” from the remainder of the cupboard monument. The sleeping-space wall surrounds the bed (or else several beds, see below) at least when and at least partially when the bed is in the state of use. The sleeping-space wall may optionally also surround several beds. The sleeping-space wall serves to create a private sphere for a person resting on the bed. In other words, the first wall section at least partially surrounds the bed or beds. The cupboard monument is thus a cabin monument, in particular a storage cupboard module which also offers storage for other objects in addition to the bed. A corresponding monument can be configured in a manner which is particularly appealing visually in order to integrate the bed into the passenger cabin.

In particular, the cupboard monument can be connected to necessary systems (air, electricity) on the PSC (Passenger Service Channel) of the hat racks (overhead storage bins).

In particular, therefore, the space between the first row of passenger seats and the door region can be used for a cupboard module in the form of a stowage module with two integrated folding beds.

In order to allow the passengers to board and alight and for evacuation, the folding parts of the beds (moving sections) can easily be swung/folded back into the cupboard module.

The cupboard module thus also has, in particular, at least one storage compartment. In this way, a flexible, small footprint is created for the cupboard module/the beds.

In one preferred variant of this embodiment, the first wall section has a cabin window. The cabin window is a window which penetrates the outer wall of the passenger aircraft. From the bed or the abovementioned sleeping space bounded by the sleeping-space wall, it is thus also possible to see out of the passenger aircraft.

In one preferred variant of this embodiment in combination with the moving section explained above, the moving section in the stowed state forms a housing section of a housing which surrounds the cupboard monument (at least when the bed(s) of the cupboard monument are in the stowed state). In other words, in the stowed state of the bed, the cupboard monument then has a housing/outer surface/boundary which is, in particular, completely closed and thus visually appealing and is particularly suitable for storing material to be stored.

In one preferred embodiment, the previously mentioned bed is a first bed. The cabin section, in particular the cupboard monument, then contains a second bed (or even more), which corresponds to the first bed. The second bed is therefore likewise a bed according to the invention of the kind previously explained. In this case, both beds or the plurality of beds can be supported on the same flight attendant seat. In particular, however, the cabin section contains a second (or additional) flight attendant seat(s). Each of the beds is then supported on an associated seat.

In one preferred variant of this embodiment, the second bed, at least in the state of use, is disposed parallel and adjacent to the first bed when the latter is likewise in the state of use. In other words, it is possible in this way to create an equivalent double or multiple resting space or lying space for cabin crew.

In one preferred variant of this embodiment, the cabin section, in particular the cupboard monument, has at least one partition wall between in each case two of the beds. This extends, in particular, at least in an intended head or upper body region of the respective beds in order to create a private sphere even between individual beds. The partition wall is therefore, in particular, a component part of the cupboard monument.

In one preferred embodiment, the cabin section contains a mobile dividing element. The dividing element can be adjusted between a state of use and a stowed state. At least in the state of use, the dividing element is, or at least part of the dividing element forms, a second wall section of a sleeping-space wall of the kind already explained above. This may also actually be the abovementioned sleeping-space wall. The sleeping-space wall thus surrounds the bed or several beds at least in the state of use, or the bed is at least partially bounded by the sleeping-space wall. The sleeping-space wall therefore bounds a sleeping space or sleeping area in which the beds are located.

The dividing element is, in particular, a curtain (alternatively a folding screen etc.), which is pulled forward or back in order to switch between the state of use and the stowed state.

In particular, the sleeping-space wall is formed by the abovementioned first wall section, the second wall section, the entrance door mentioned, and the cabin wall section behind the flight attendant seat. Thus, this (together with the ceiling and floor in the corresponding section of the passenger cabin) forms a completely enclosed sleeping space, which in a particularly effective way offers a private sphere for persons resting on the bed or present in the sleeping space.

The invention is based on the following insights, observations and considerations and also has the following preferred embodiments. By way of partial simplification, these embodiments are also referred to here as “the invention”. Here, the embodiments may also contain parts or combinations of the abovementioned embodiments or correspond thereto and/or optionally also include embodiments that have not been previously mentioned.

According to the invention, what is obtained is, in particular, a foldable sleeping/lying-down facility for cabin crew. In this case, it is possible, during the flight, to fold out two lying surfaces for two persons from a storage cupboard module, the surfaces being supported on the seat bottoms of two opposite flight attendant seats (or cabin attendant seats (CAS)).

The invention is based on the observation that single-aisle aircraft are increasingly being used for long-distance routes; this gives rise to the requirement for on-board resting facilities for the cabin crew.

It would be conceivable to reserve passenger seats for the crew (flight attendants) and to separate them from the rest of the passenger cabin by using curtains. However, this would mean that the seats could not be sold to passengers. In general, they offer only the possibility for relaxed sitting but not the function of a fully horizontal lying surface.

The invention is based on the concept of installing, in particular, a storage cupboard (cupboard monument) in a relatively small space adjacent to the aircraft entry area. This contains two fold-out portions (moving section) of lying surfaces, and these are supported on the opposite seat bottoms of the flight attendant seats (CAS), thus rendering additional supports for the lying surfaces unnecessary.

This gives rise to a resting area for two flight attendants, with two beds for sleeping and recuperation. This is additionally separated from the aisle area by a curtain (mobile dividing element) and thus creates the necessary private sphere.

The advantage is: fewer seats are occupied by the crew, and the seats can thus be sold to the passengers. Two completely horizontal lying surfaces (beds) are created, in comparison with seats, which can generally only be made somewhat more comfortable by inclining the seat backs. The lying surfaces can be quickly folded in and out, thus enabling flexible use of the area (floor section).

The invention is based on the insight that in this way rational use is made of the area in front of the aircraft doors during the flight. The use of the existing flight attendant seats, of the seat bottoms as points of support for the fold-out lying surfaces, eliminates additional mechanical elements (supports). The requirement for rapid installation and removal of the lying surfaces is met. In the raised, stowed state, the lying surfaces are flush with the rest of the storage cupboard wall (housing), thus creating a tidy overall impression.

Other features which are considered as characteristic for the invention are set forth in the appended claims.

Although the invention is illustrated and described herein as embodied in a cabin section of a passenger cabin of a passenger aircraft having a bed supported against a flight attendant seat, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, side-elevational view of a cabin section of a passenger cabin, as seen in the direction of an arrow I in FIG. 2;

FIG. 2 is a plan view of the cabin section of FIG. 1, as seen in the direction of an arrow II in FIG. 1;

FIG. 3 is a side-perspective view of an alternative cabin section with folded-down beds, as seen in the direction of an arrow III in FIG. 5;

FIG. 4 is a perspective view of the cabin section of FIG. 3 with the beds raised; and

FIG. 5 is a perspective view of the cabin section of FIGS. 4 and 5, as seen in the direction of an arrow V in FIGS. 3 and 4.

### DETAILED DESCRIPTION OF THE INVENTION

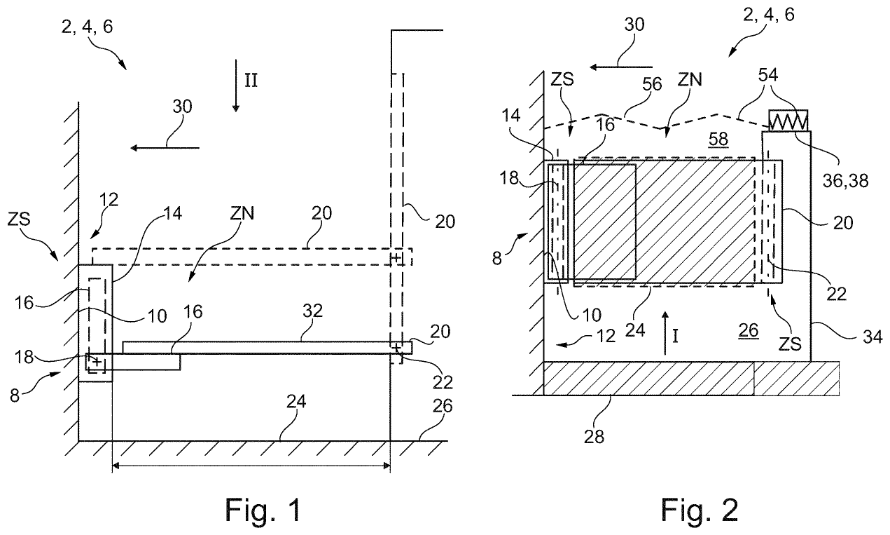

Referring now to the figures of the drawings in detail and first, particularly, to FIGS. 1 and 2 thereof, there is seen a segment of a passenger cabin 2 (not further illustrated) of a passenger aircraft 4. The illustrated segment of the passenger cabin 2 contains a cabin section 6. The cabin section 6 contains a flight attendant seat 8, which is mounted on a cabin wall section 10 of a cabin wall 12 of the passenger cabin 2. The flight attendant seat 8 can be adjusted between a state of use ZN, illustrated in solid lines, and a stowed state ZS, illustrated in dashed lines. For the adjustability, the flight attendant seat 8 has a base or supporting unit mounted in a fixed manner on the cabin wall section 10 and having a seat back 14 and a seat bottom 16. The seat bottom 16 is adjustable, pivotable or foldable, in this case by 90°, between the state of use ZN and the stowed state ZS about a folding axis 18 extending in a horizontal direction. “Horizontal” refers to a passenger aircraft 4 resting on a level underlying surface.

The cabin section 6 furthermore contains a bed 20, which can likewise be adjusted (the description relating to the flight attendant seat 8 applies mutatis mutandis) between a state of use ZN (illustrated in solid lines) and a stowed state ZS (illustrated in dashed lines). For this purpose, the bed 20 can also be folded by 90° about a folding axis 22.

The cabin section 6 furthermore contains a floor section 24 (hatched and illustrated on a somewhat enlarged scale for the sake of clarity in FIG. 2) of a floor 26 of the passenger cabin 2. When the flight attendant seat 8, on the one hand, and the bed 20, on the other hand, are both in the stowed state ZS, the floor section 24 is located between these two elements and is available to be walked on by passengers or flight attendants. “Between” refers to a vertical projection from above with the aircraft at rest in a horizontal and level position, see the double arrow in FIG. 1. When the flight attendant seat 8 is in the state of use ZN, it partially covers the floor section 24. In contrast, the bed 20 completely covers the floor section 24 in the state of use. FIG. 2 shows the plan view of the floor 26 and therefore the complete coverage of the area of the floor section 24.

In the state of use ZN, the bed 20 is supported on the flight attendant seat 8, this being visible, in particular, in FIG. 1. Here, the way in which the bed 20 is supported on the seat bottom 16 of the flight attendant seat 8 is illustrated in solid lines. An alternative in dashed lines illustrates that an alternative bed 20 could be supported on the seat back 14 or a corresponding basic structure of the flight attendant seat 8.

In FIG. 2, it can be seen that the floor section 24 is a floor section directly adjoining an entrance door 28 of the passenger aircraft 4 or passenger cabin 2, in other words an entrance region through which passengers (not illustrated) enter (board) or leave (deboard) the passenger cabin 2. Relative to a (straight-ahead) direction of flight 30 of the passenger aircraft 4, the flight attendant seat 8 is located in front of the bed 20.

In FIGS. 1 and 2, the entire bed 20 forms a moving section 32 of the bed 20, which, in the stowed state ZS, is adjusted relative to the state of use ZN, in this case being raised through 90° about the folding axis 22. The moving section 32 is not capable of further adjustment within itself and, here in the present example in FIGS. 1 and 2, is a component that is mechanically fixed or rigid in the technical sense (except for flexibility, resilience, cushioning, etc. of a lying surface of the bed 20). The moving section 32 is at least not capable of being further tilted, folded or changed in any other way for adjustment between the state of use ZN and the stowed state ZS.

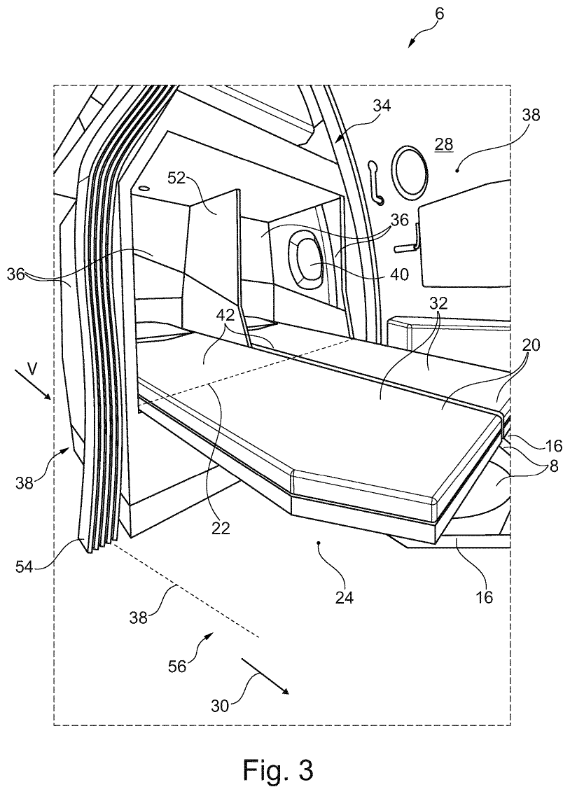

FIG. 3 shows an alternative cabin section 6, which, in this case, contains a total of two beds 20 as well as a cupboard monument 34. The cupboard monument 34 contains the two beds 20. The cabin section 6 also contains two flight attendant seats 8. In the state of use ZN illustrated, each of the beds 20 is supported on one of the flight attendant seats 8. Here, they are once again supported on the seat bottoms 16 of the flight attendant seats 8, as in the embodiment according to FIGS. 1 and 2.

The cupboard monument 34 furthermore contains a first wall section 36 of a sleeping-space wall 38, the sleeping-space wall 38. Overall (see below), the sleeping-space wall 38 completely surrounds the beds 20 and forms an enclosed sleeping space 58 in its interior, in which the beds 20 are located. Here, the first wall section 36 is in the form of a niche open on one side. The first wall section 36 also contains a cabin window 40, which penetrates the outer wall (not denoted specifically) of the passenger aircraft 4 or passenger cabin 2.

In the embodiment under consideration, the beds 20 are each divided into two, this being indicated by a dashed line, which again corresponds to the folding axis 22. That is to say, they each have a moving section 32 serving as a leg or lower-body region. As explained above, this is adjusted between the state of use ZN and the stowed state ZS (90° pivot about the folding axis 22). However, each of the beds 20 also has a respective fixed section 42, which is not adjusted or does not have to be adjusted for the changeover between the state of use ZN and the stowed state ZS. In each case, this forms a head or upper-body region of the beds 20.

In the state of use ZN, the second bed 20 is disposed parallel and adjacent to the first bed 20. The cabin section 6, in this case the cupboard monument 34, also contains a partition wall 52 between the two beds 20. This is located between the respective head regions of the two beds 20, which are provided with the intention that the persons lie in the corresponding lying direction on the beds 20.

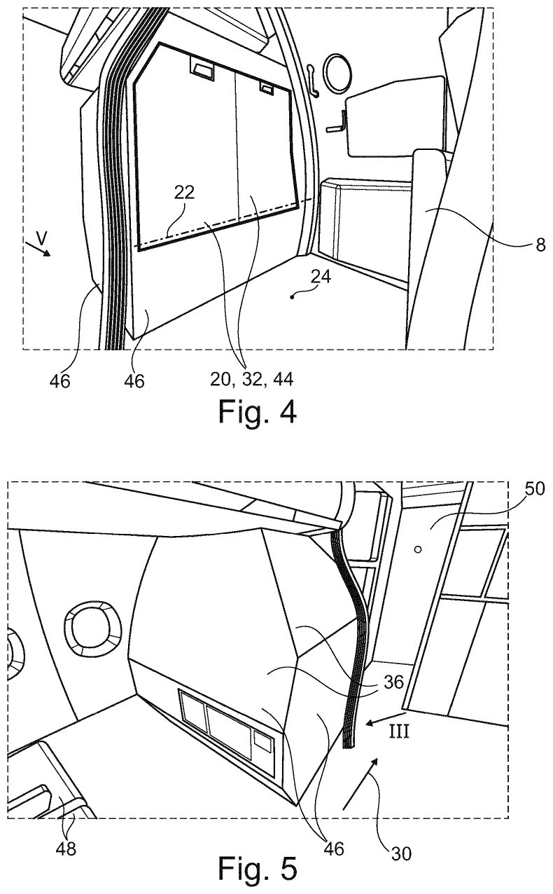

FIG. 4 shows the cabin section 6 from FIG. 3, wherein both the flight attendant seat 8 and the beds 20 are each now in the stowed state ZS. The moving sections 32 are folded upward through 90° about the folding axis 22 and form a respective housing section 44 of a housing 46 that surrounds the entire cupboard monument 34.

FIG. 5 illustrates the housing 46 by a view of the cabin section 6 illustrated in FIGS. 3 and 4 in the direction of the arrow V in FIGS. 3 and 4, that is to say when viewed obliquely in the direction of flight 30. In other words, the cupboard monument 34 or the housing 46 thereof can be seen here from its “rear side” or from the passenger region (not explained further) of the passenger cabin 2, in which passenger seats 48 are located. When viewed in the direction of flight 30, the cabin section 6 is located at the forwardmost end of the passenger cabin 2, as can be discerned from the cockpit door 50 illustrated in FIG. 5.

The cabin section 6 furthermore contains a mobile dividing element 54, here in the form of a dividing curtain. This is shown in a stowed state ZS in FIGS. 2 to 5 (shown in solid lines in FIG. 2). In FIGS. 2 to 3, the state of use ZN (i.e. “curtain drawn”) is also indicated symbolically in dashed lines (in FIG. 3 by a dashed line of the sleeping-space wall 38). In a state of use ZN, the mobile dividing element 54 forms a second wall section 56 of the sleeping-space wall 38, which then completely surrounds both beds 20 and thus bounds an enclosed sleeping space 58. In order to form the sleeping-space wall 38, the first wall section 36 (cupboard monument 34) and the second wall section 56 (drawn curtain), the cabin wall section 10 and the entrance door 28 cooperate or complement one another to form the sleeping-space wall 38. Thus, the sleeping-space wall 38 surrounds the beds 20 completely, at least in the state of use ZN, and creates a private sphere for persons on the beds 20 or in the sleeping space 58.

The following is a summary list of reference numerals and the corresponding structure used in the above description of the invention:
2 passenger cabin
4 passenger aircraft
6 cabin section
8 flight attendant seat
10 cabin wall section
12 cabin wall
14 seat back
16 seat bottom
18 folding axis
20 bed
22 folding axis
24 floor section
26 floor
28 entrance door
30 direction of flight
32 moving section
34 cupboard monument
36 first wall section
38 sleeping-space wall
40 cabin window
42 fixed section
44 housing section
46 housing
48 passenger seats
50 cockpit door
52 partition wall
54 mobile dividing element
56 second wall section
58 sleeping space
ZN state of use
ZS stowed state

1. A cabin section of a passenger cabin of a passenger aircraft, the cabin section comprising:
a flight attendant seat being adjustable between a state of use and a stowed state, said flight attendant seat being a folding seat with a seat back mounted in a fixed manner in the passenger aircraft, and a movable seat bottom being foldable upward about a horizontally extending folding axis to assume said stowed state;
a bed being adjustable between a state of use and a stowed state, said bed being a folding bed being foldable upward about a horizontal folding axis into said stowed state;
a floor section of a floor of the passenger cabin, said floor section being located between said flight attendant seat and said bed when said flight attendant seat and said bed both assume said stowed state, placing said flight attendant seat and said bed at opposite ends of said floor section, delimiting said floor section, and making said floor section available to be walked on;
said floor section being partially covered by said flight attendant seat in said state of use, being at least partially covered by said bed in said state of use and being completely covered by said flight attendant seat and said bed together in said state of use; and
said bed being supported on said flight attendant seat in said state of use.

2. The cabin section according to claim 1, wherein said bed in said state of use is supported on said seat bottom of said flight attendant seat.

3. The cabin section according to claim 1, wherein said flight attendant seat is mounted on a cabin wall section of a cabin wall of the passenger cabin.

4. The cabin section according to claim 1, wherein said floor section directly adjoins an entrance door of the passenger cabin.

5. The cabin section according to claim 1, wherein said flight attendant seat is disposed in front of said bed in a direction of flight of the passenger aircraft.

6. The cabin section according to claim 1, wherein said bed has at least one moving section being adjusted relative to said state of use in said stowed state of said bed.

7. The cabin section according to claim 6, wherein said moving section is not capable of further adjustment within itself.

8. The cabin section according to claim 6, wherein, in addition to said moving section, said bed has a fixed section which cannot be forcibly adjusted between said state of use and said stowed state.

9. The cabin section according to claim 1, which further comprises:
a cupboard monument;
a sleeping-space wall having a first wall section;
said cupboard monument containing said bed and said first wall section; and
said sleeping-space wall at least partially surrounding said bed, at least in said state of use.

10. The cabin section according to claim 9, wherein said first wall section is a cabin window.

11. The cabin section according to claim 9, wherein:
said bed has at least one moving section being adjusted relative to said state of use in said stowed state of said bed; and
in said stowed state, said moving section forms a housing section of a housing surrounding said cupboard monument.

12. The cabin section according to claim 1, wherein said bed is a first bed, and the cabin section contains a second bed being adjustable between a state of use and a stowed state.

13. The cabin section according to claim 12, wherein said second bed, at least in said state of use, is disposed parallel to and adjacent to said first bed in said state of use.

14. The cabin section according to claim 12, which further comprises at least one partition wall disposed between said first and second beds.

15. The cabin section according to claim 9, which further comprises a mobile dividing element being adjustable between a state of use and a stowed state, said mobile dividing element, in said state of use, being another wall section of said sleeping-space wall, said sleeping-space wall surrounding said bed, at least in said state of use.
